(19) United States
(12) Patent Application Publication
(10) Pub. No.: US 2001/0045709 A1
(43) Pub. Date: Nov. 29, 2001

(54) SEAL RING AND JOINT

(76) Inventor: JOHN EDWARD STOBBART, SWANSEA (GB)

Correspondence Address: ALTERA LAW GROUP, 6500 CITY WEST PARKWAY, SUITE 100, MINNEAPOLIS, MN, 55344-7701, US

(21) Appl. No.: 09/429,194

(22) Filed: Oct. 28, 1999

(51) Int. Cl. H02G 15/013

(52) U.S. Cl. 277/602

(57) ABSTRACT

A seal ring (4) and a connection joint (1) for connecting and sealing conduits/pressure vessels (2, 3) and the like is disclosed. The seal ring comprises a radially inner sealing portion (5) having annular seal lips (6, 7) sloping radially outwardly to a web portion (8), the web portion extending radially outwardly to an outer scaling portion (9). Said outer sealing portion (9) having annular seal lips (10, 11) sloping radially inwardly towards the web (8). The annular seal lips of the inner sealing portion (5) face the annular seal lips of the outer scaling portion (9) and extend in a transverse direction to said web (8). This configuration provides improved seal characteristics giving particular benefit where there are high external pressures surrounding the joint (1) e.g. in deep sea applications. The joint (1) comprises a seal ring (4) interposed at an interface between two conduct (or vessel) members (2, 3), the conduit or vessel members being provided with respective recesses (12, 13) arranged to receive the inner and outer sealing lips (5, 9) of the seal ring (4).

### BACKGROUND OF THE INVENTION

The present invention relates to a seal ring and connection joint for conduits, pressure vessels or the like.

When connecting adjacent sections of fluid flow conduits or vessels seal rings are typically interposed at the interface of adjacent connecting flanged conduits or vessel portions which are then bolted or clamped together. Where or vessel, the seal ring is typically metallic, the seal being affected by elastic or plastic deformation of a sealing surface of the seal ring against sealing portions of the ranged portions.

Known seal rings and joints of the general type are disclosed, for example, in UK Patent Specifications 742213, 854189, 952755, 1035958 and 152546, PCT Specification WO91/19128, and U.S. Pat. No. 5,466,018 (Stobbart).

The known seal rings and joints work, to a greater or lesser extent, when the pressure within the conduit, pressure vessel or the like is considerably greater than the ambient pressure outside of the conduit, pressure vessel or the like i.e. the seal or joint is pressure energised. They do, however, work less satisfactorily when the internal and external pressures are similar or, even, when the external pressure is greater than the internal pressure, i.e. the seal is not pressure energised.

### SUMMARY OF THE INVENTION

We have now devised and improved seal ring and associated connection joint.

According to a first aspect of the invention there is provided an annular seal ring comprising an inner integrally formed sealing portion, an outer integrally formed sealing portion, and an interconnecting web portion, said inner sealing portion comprising a pair of annular seal lips facing said outer sealing portion and extending in a transverse direction to said web portion, said outer seal portion comprising a pair of annular seal lips facing said inner seal portion and extending in a transverse direction to said web portion, which web portion extends radially between said pair of seal lips on the inner seal portion and said pair of seal lips on the outer seal portion, and each respective seal lip is arranged to project transversely from said web portion by a distance which is substantially greater than the thickness of said web portion in a direction substantially perpendicular to the radial direction.

The pair of annular seal lips on the inner seal portion are preferably arranged each on a respectively radially outer portion of the inner sealing portion. The pair of inner annular seal lips may slope radially outward and toward one another to the web portion with a continuous radially outward slope. Said continuous slope may be a slope of constant inclination to the radial direction. Alternately said continuous slope may be of varying inclination relative to the radial direction.

Alternately, the pair of inner annular seal lips comprise a portion sloping radially outwardly and toward one another to the web portion and a portion that is substantially perpendicular to the radial direction, the portion of the seal lip that is substantially perpendicular to the radial direction being between the web portion and the sloping portion of the inner annular seal lips. Said continuous slope may be a slope of constant inclination to the radial direction. Alternately said continuous slope may be of varying inclination relative to the radial direction.

The pair of outer annular seal lips are preferably arranged each on a respectively radially inner portion of the outer seal portion. The pair of outer annular seal lips may slope radially inwardly and toward one another to the web portion. Said continuous slope may be a slope of constant inclination to the radial direction. Alternately said continuous slope may be of varying inclination relative to the radial direction.

Alternately, the pair of outer annular seal lips may consist of a portion sloping radially inwardly and toward one another to the web portion, and a portion substantially perpendicular to the radial direction, the substantially perpendicular to the radial direction portion of the outer pair of annular seal lips being between the radially inwardly sloping portion of the outer annular seal lips and the web portion. Said continuous slope may be a slope of constant inclination to the radial direction. Alternately said continuous slope may be of varying inclination relative to the radial direction.

Typically, the radially inner face of the pair of inner annular seal lips are co-planar, thereby defining a substantially continuous annular radially inner surface for the seal ring. Typically, the radially outer surface of the outer annular seal lips are co-planar, thereby defining a substantially continuous annular radially outer surface of the seal ring.

It is preferred that the transversely projecting limits of the radially inner surface of the seal ring and of the radially outer surface of the seal ring are provided with respective tapered or chamfered portions. Said tapering or chamfering being in a radially outward direction on the radially inner surface of the seal ring and in a radially inner direction on the radially outer surface of the seal ring.

Typically, the inner annular seal ring and outer annular seal ring project transversely from the web portion by substantially equal distances.

It is preferred that the web portion is provided with substantially parallel opposed radially extending surfaces which are advantageously substantially parallel to the radial direction.

It is preferred that the dimensions of the inner annular seal ring and the outer annular seal ring are substantially equal.

Typically, the seal ring is principally or wholly of metallic material, plastics material, or a combination of both.

According to a second aspect of the invention, there is provided a conduit joint comprising a seal ring according to the first aspect of the invention interposed at an interface between a pair of conduits or vessel defining members, said conduits or vessel defining members being provided at said interface with respective recessed portions, complementarily shaped and dimensioned to receive respective portions of the inner and outer annular seal ring wherein a first inner recessed portion comprises a radially outer surface sloped away from the interface in an inwardly radial direction, and a second of said recessed portions comprises a radially inner surface sloping away from said interface in an outwardly radial direction.

The surfaces of the recesses sloping away from the interface are, advantageously, frustoconical or part spherical.

Alternately, said respective recessed portions provided at said interface of said conduits or vessel defining members are complementarily shaped and dimensioned to receive respective portions of the inner and outer annular seal ring wherein a first inner recessed portion comprises a radially outer surface of which a portion is sloped away from the interface in a radially inwardly direction and a portion is substantially perpendicular to the radial direction portion being between the interface and the radially inwardly sloping portion, and a second outer recessed portion comprises a radially inner surface of which a portion is sloped away from the interface in a radially outward direction and a portion is substantially perpendicular to the radial direction, the substantially perpendicular to the radial direction portion being between the interface and the radially outwardly sloping portion.

In use an inner sealing lip is received in the first one of the recessed portions of a conduit or vessel defining member, with a respective outer sealing lip abutting the second one of said recessed portions. Corresponding first and second recessed portions of the other conduit or vessel defining member are arranged to receive/abut the corresponding other inner and outer sealing lips of the seal ring.

Typically, the conduit defining or vessel defining members will be flanged members arranged to be bolted or clamped together with the seal ring interposed there between to form a sealed joint.

In one embodiment of the invention at least one of the conduit defining or vessel defining members is a conduit defining member provided with pressure tapping means extending from the exterior surface of the conduit defining member to communicate with the respective interface surface at a location intermediate between the recessed portions, which is shaped to receive the inner and outer seal rings. In this embodiment it is generally necessary to provide a pressure balancing hole in the web portion.

It is a particular advantage of the seal ring of this invention that both the inner and outer annular seal rings create a seal, failure of the seal created by one of the inner or outer annular seal rings will not cause total failure of the sealing of the joint. The remaining seal should be sufficient to maintain the sealing of the joint until appropriate remedial action can be undertaken. Such failure may, in particular, result from damage to seal ring inflicted whilst the joint was being constructed.

The invention will now be further described in specific embodiments by way of example only with reference to the accompanying drawings:

### BRIEF DESCRIPTION OF THE DRAWINGS

FIG. 1 is a cross sectional view of a joint according to the second aspect of the invention provided with a seal ring according to the first aspect of the invention;

FIG. 2 is a cross sectional view of a part of the seal ring of FIG. 1;

FIG. 3 is a sectional assembly view of part of the joint and seal ring shown in FIGS. 1 and 2; and

FIG. 4 is a sectional view of part of a modified joint and seal ring according to the first and second aspects of the invention.

### DETAILED DESCRIPTION OF THE PREFERRED EMBODIMENTS

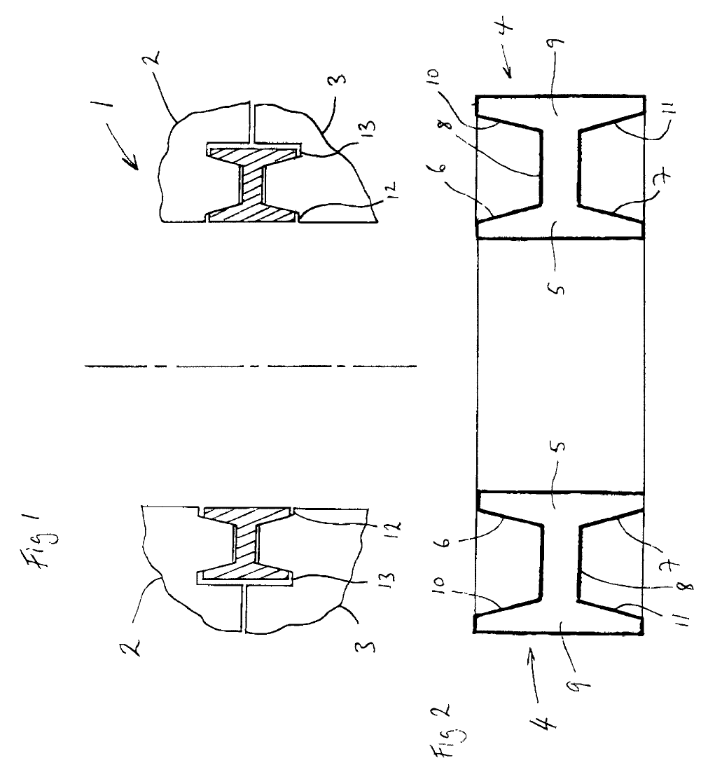

Referring to the drawings, and initially to FIG. 1, a joint generally designated 1 comprises first and second flange connecting members 2, 3 bolted at an interface to define an axial fluid flow path or confined space, such as in a pressure vessel. An annular metallic seal 4 (typically of a forged nickel alloy, for example Alloy 625, Alloy 718, or Alloy X750) is provided at the interface interposed between the flanged members 2, 3 and serves to prevent fluid leaking out of the fluid flow path at the interface or into the joint at the interface from outside the flange connecting members 2, 3. The seal may withstand external pressures equivalent to depths of up to and over 5,000 meters of sea water without leakage of fluid into the joint at the interface. This is particularly desirable when the joint is intended for use in deep sea environments.

The type and exact composition of the material used to make the seal ring is determined by, amongst other factors, the corrosive nature of the environment in which the seal is to be located, the temperature at which the seal is to be operated, and the materials compatibility with the material to be used to form the conduit or pressure vessel in which a joint is to be created and the seal ring employed. The material of the seal ring may be wholly or principally of metal, plastics, or a combination thereof.

The annular seal ring 4 comprises an inner sealing portion 5 having angled sealing lips 6, 7 a web 8, and an outer sealing portion 9 having angled sealing lips 10, 12. Inner sealing portion 5 and outer sealing portion 9 both extend substantially transversely to the web portion. Inner sealing portion 5 is connected to the radially inner end of web portion 8 and outer seal portion 9 is connected to the radially outer end of web portion 8. As shown in FIG. 1, inner sealing portion 5 and outer sealing portion 9 are received in complementarily shaped recesses or grooves 12, 13 extending circumferentially around the flange connecting members 2, 3 at their interface.

It is preferred that the dimensions of the inner and outer sealing portions 5, 9 of seal ring 4 are substantially similar to each other. This results in the inner and outer sealing portions undergoing substantially equal amounts of deformation on tightening of the joint.

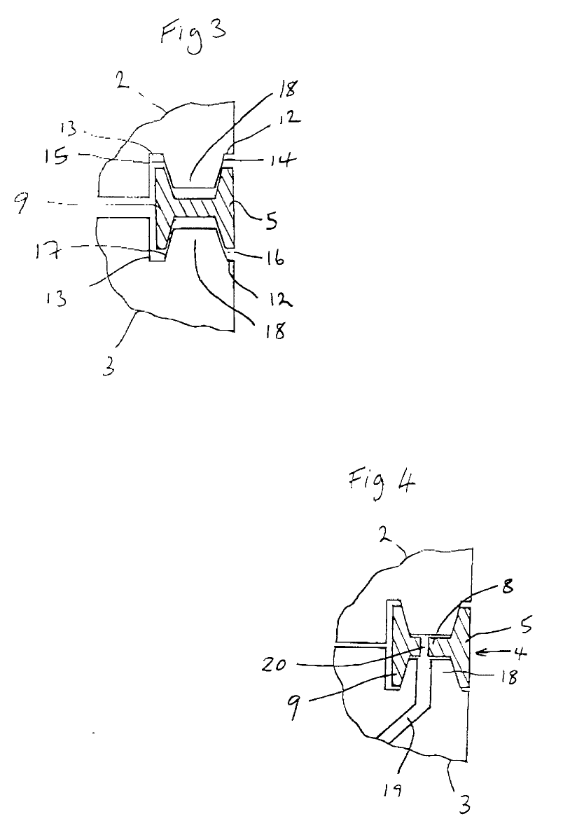

Referring to FIG. 3, on assembly of joint 1 each of the portions of inner sealing portion 5 and outer sealing portion 9 are located within an annular recess 12 or 13 respectively. As flanged members 2 and 3 are moved towards each other, sealing lips 6 and 10 engage with seal faces 14, 15 on inside faces of recesses 12 and 13 in flange member 2 respectively. At substantially the same time, sealing lips 7 and 11 engage with seal faces 16 and 17 in recesses 12 and 13 in flange member 3.

The contact between sealing lips 6, 7, 10 and 11 and sealing faces 14, 16, 15 and 17 respectively causes flange members 2 and 3 align with each other if they are not already aligned.

The portion of flanges 2 and 3 between recesses 12 and 13 forms a raised annular rib 18. Said rib 18 is dimensioned so that the sealing faces 14 and 15 on flange member 2 and 16 and 17 on flange member 3 cause deformation of annular seal ring 4 when flange members 2 and 3 are bolted or clamped together. The deformation is such that a liquid and gas tight seal is formed between sealing lip 6 and sealing face 14, sealing lip 7 and sealing face 16, sealing lip 10 and sealing face 15, and sealing lip 11 and sealing face 17.

Referring to FIG. 4, a modification of the seal ring 4 and flange members 2 and 3 is shown where flange member 3 is provided with a pressure tapping 19 from the exterior of joint 1 (not shown) to the face of annular rib 18 adjacent, in use, to web 8 of annular seal ring 4. Web 8 of annular seal ring 4 is provided with a pressure equalising bore 20 extending between the two substantially radially extending faces of web 8.

When joint 1 is fully tightened, a fluid at known pressure is applied to pressure tapping 19. The ratio of decrease of that pressure indicates the efficacy of the seals made in the joint. Thus an efficient means of testing the joint is provided prior to pressurising the conduit or pressure vessel with fluid. Alternately, the pressure within the pressure tapping 19 is monitored when the conduit or pressure vessel is pressurised. A change in pressure in the pressure tapping 19 may indicate a leak in the seal.

I claim:

1. An annular seal ring comprising an inner integrally formed sealing portion, an outer integrally formed sealing portion, and an interconnecting web portion, said inner sealing portion comprising a pair of annular seal lips facing said outer sealing portion and extending in a transverse direction to said web portion, said outer seal portion comprising a pair of annular seal lips facing said inner seal portion and extending in a transverse direction to said web portion, which web portion extends radially between said pair of seal lips on the inner seal portion and said pair of seal lips on the outer seal portion.

2. A seal ring according to claim 1, wherein the pair of inner annular seal lips may slope radially outward and toward one another to the web portion with a continuous radially outward slope.

3. A seal ring according to claim 1, wherein the pair of inner annular seal lips comprise a portion sloping radially outwardly and toward one another to the web portion and a portion that is substantially perpendicular to the radial direction, the portion of the seal lip that is substantially perpendicular to the radial direction being between the web portion and the sloping portion of the inner annular seal lips.

4. A seal ring according to claim 1, wherein the pair of outer annular seal lips may slope radially inwardly and toward one another to the web portion.

5. A seal ring according to claim 1, wherein the pair of outer annular seal lips may consist of a portion sloping radially inwardly and toward one another to the web portion, and a portion substantially perpendicular to the radial direction, the substantially perpendicular to the radial direction portion of the outer pair of annular seal lips being between the radially inwardly sloping portion of the outer annular seal lips and the web portion.

6. A seal ring according to claim 1, wherein the radially inner face of the pair of inner annular seal lips are co-planar, thereby defining a substantially continuous annular radially inner surface for the seal ring.

7. A seal ring according to claim 1, wherein the radially outer surface of the outer annular seal lips are co-planar, thereby defining a substantially continuous annular radially outer surface of the seal ring.

8. A seal ring according to claim 1, wherein the transversely projecting limits of the radially inner surface of the seal ring and of the radially outer surface of the seal ring are provided with respective tapered or chamfered portions.

9. A seal ring according to claim 8, wherein said tapering or chamfering is in a radially outward direction on the radially inner surface of the seal ring and in a radially inner direction on the radially outer surface of the seal ring.

10. A seal ring according to claim 1, wherein the inner annular seal ring and outer annular seal ring project transversely from the web portion by substantially equal distances.

11. A seal ring according to claim 1, wherein the web portion is provided with substantially parallel opposed radially extending surfaces.

12. A seal ring according to claim 11, wherein the radially extending surfaces of the web are substantially parallel to the radial direction.

13. A seal ring according to claim 1, wherein the dimensions in cross section of the inner annular seal ring and the outer annular seal ring are substantially equal.

14. A seal ring according to claim 1, wherein the seal ring is of a metallic material.

15. A seal ring according to claim 14, wherein the metallic material is a forged nickel alloy.

16. A conduit joint comprising a seal ring according to claim 1 interposed at an interface between a pair of conduits or vessel defining members, said conduits or vessel defining members being provided at said interface with respective recessed portions, complementarily shaped and dimensioned to receive respective portions of the inner and outer annular seal ring wherein a first inner recessed portion comprises a radially outer surface sloped away from the interface in an inwardly radial direction, and a second of said recessed portions comprises a radially inner surface sloping away from said interface in an outwardly radial direction.

17. A conduit joint of claim 16, wherein the surfaces of the recesses sloping away from the interface are, advantageously, frustoconical or part spherical.

18. A conduit joint comprising a seal ring according to claim 1 interposed at an interface between a pair of conduits or vessel defining members being provided at said interface with respective recessed portions provided at said interface of said conduits or vessel defining members are complementarily shaped and dimensioned to receive respective portions of the inner and outer annular seal ring wherein a first inner recessed portion comprises a radially outer surface of which a portion is sloped away from the interface in a radially inwardly direction and a portion is substantially perpendicular to the radial direction, the substantially perpendicular to the radial direction portion being between the interface and the radially inwardly sloping portion, and a second outer recessed portion comprises a radially inner surface of which a portion is sloped away from the interface in a radially outward direction and a portion is substantially perpendicular to the radial direction, the substantially perpendicular to the radial direction portion being between the interface and the radially outwardly sloping portion.

19. A conduit joint of claim 18, wherein the surfaces of the recesses sloping away from the interface are frustoconical or part spherical.
